(19) United States
(12) Patent Application Publication
(10) Pub. No.: US 2002/0191719 A1
(43) Pub. Date: Dec. 19, 2002

(54) Differential signal-delaying apparatus, receiver employing the apparatus, and communication system

(75) Inventors: Satoshi Hasako, Iizuka (JP); Yuji Igata, Tukushino (JP); Masahiro Maki, Iizuka (JP); Junji Kondou, Tagawa-Gun (JP)

Correspondence Address: DARBY & DARBY P.C., P. O. BOX 5257, NEW YORK, NY, 10150-5257, US

(73) Assignee: Matsushita Electric Industrial Co., Ltd.

(21) Appl. No.: 10/172,789

(22) Filed: Jun. 14, 2002

(30) Foreign Application Priority Data
Jun. 18, 2001 (JP) 2001-183183

(51) Int. Cl. H04B 1/10

(52) U.S. Cl. 375/346

(57) ABSTRACT

Two different delay units delay first and second signals of a differential signal, thereby generating two different delay signals, respectively. A delay control unit controls respective delay times in the two different delay units, thereby varying a delay time difference between the respective delay times in the two different delay units. An error-detecting unit detects an error in the differential signal for each change in delay time deference. A counting unit counts the number of errors per predetermined time. The delay control unit sets the respective delay times in the two different delay unit to a delay time difference in which the number of times of errors per predetermined time is minimized. As a result, the occurrence of differential signal skew-caused errors is suppressed to an extreme extent.

### BACKGROUND OF THE INVENTION

1. Field of the Invention

The present invention relates to a differential signal-delaying apparatus for delaying a received differential signal in a differential data transmission system, and an art related thereto.

2. Description of the Related Art

A specification published on Apr. 2, 1999, entitled “Digital Visual Interface Revision 1.0” (hereinafter a “DVI specification”) has heretofore been established as a standard for transmitting digital video data at high speeds by means of a differential signal. For more information on the transmission standard, refer to http://www.ddwg.org/.

FIG. 7 is a block diagram, illustrating a prior art receiver constructed according to the DVI specification. As illustrated in FIG. 7, the receiver includes a differential-amplifying unit 10, a serial/parallel-converting unit (or a S/P-converting unit) 11, and an 8B10B decoder 12. The differential-amplifying unit 10 receives a differential signal that is sent from a transmitter (not shown) through a twisted-pair cable. The differential signal includes one signal X1 and another signal X2, each of which is a serial signal and 10-bit redundant code. The differential-amplifying unit 10 generates signal “Z” according to the potential difference between signals X1, X2. The S/P-converting unit 11 converts the signal Z (a serial signal) from the differential-amplifying unit 10 into a parallel signal. The 8B10B decoder 12 decodes the parallel signal (a 10-bit redundant code) from the S/P-converting unit 11, and then provides the decoded signal as 8-bit parallel data.

However, the prior art receivers as discussed above fail to deal with data errors caused by a differential signal skew (a difference in time between the arrival of the two differential signals). Such a drawback will now be described in detail.

FIGS. 8(a)-(c) are signal-timing diagrams that illustrate the adverse effects of a differential signal skew. FIG. 8(a) illustrates a skew and FIG. 8(b) illustrates the output signal “Z” from the differential-amplifying unit 10 having the differential signal skew. The pattern in FIG. 8(b) shows an overlap of the X1 and X2 signals. FIG. 8(c) illustrates the same output signal “Z”, but in the absence of the skew.

As shown in FIG. 8(a) there is a time difference “T” between the arrival of one signal X1 and another X2, both of which form a differential signal to be fed into the differential-amplifying unit 10. The arrival time difference “T” denotes the differential signal skew.

Differential signal skew, as set forth herein, refers to an “intra-pair-skew” as discussed in the DVI specification, but differs from an “inter-pair-skew” as discussed in the same DVI specification.

It can be seen from FIGS. 8(b) and 8(c) the signal data bit length L(b′) is made smaller in the presence of the differential signal skew as illustrated in FIG. 8(b) than that in the absence of the differential signal skew L(c) as illustrated in FIG. 8(c). This means that data is set to be either 0 or 1 for smaller time intervals in the presence of the skew (FIG. 8(b)) than in the absence of the skew (FIG. 8(c)). The problem is that as a result, a data value is determined with less certainty.

It is known that differential signal skew increases with an increase in length of the twisted-pair cable used to transmit the differential signal. As a result, the data value is decided with even less certainty when the cable length is made longer. A wide transmitting system according to the DVI specification typically employs a twisted-pair cable having a length ranging from 2 to 5 meters. However, in the future, the wide transmitting system is expected to use a much longer twisted-pair cable. The use of such a longer cable is likely to disturb a video image on the prior art receiver because of differential signal skew-caused data errors.

A prior art digital variable delay circuit is disclosed in published Japanese Patent Application Laid-Open No. 4-227313. The output of such a digital variable delay circuit is a delayed version of a differential signal applied to its input. The delay time is adjusted by changing the value of a current applied to the delay circuit from a variable electrical current source.

However, a purpose of this prior art digital variable delay circuit is to merely control the delay time, not to suppress the differential signal skew-caused errors. Consequently, the circuit as described above is free of countermeasures to suppress such the errors.

### OBJECTS AND SUMMARY OF THE INVENTION

In view of the above, an object of the present invention is to provide a differential signal-delaying apparatus capable of inhibiting to the utmost the occurrence of differential signal skew-caused errors, regardless of whether a great length is used for the twisted-pair cable that transmits the differential signal.

A first aspect of the present invention provides a differential signal-delaying apparatus comprising a first delay unit for delaying a first signal of an entered differential signal in order to generate a first delay signal, a second delay unit for delaying a second signal of the entered differential signal in order to generate a second delay signal, an error-detecting unit for generating an error signal when detecting an error in a signal that is based on the first and second delay signals, a counting unit for counting the number of times of errors per predetermined time upon receipt of the error signal, and a delay control unit for varying a delay time difference that is a difference between respective delay times in the first and second delay unit, wherein the counting unit counts the number of times of errors per predetermined time for each change in delay time difference to be made by the delay control unit, while the delay control unit sets the respective delay times in the first and second delay unit to respective delay times that determine a delay time difference in which the number of times of errors per predetermined time is minimized.

The above-structured differential signal-delaying apparatus practices the above delay time-setting operation including the step of locating the delay time difference in which the number of times of errors per predetermined time is minimized, and thereby provides a minimized differential signal skew. As a result, the occurrence of differential signal skew-caused errors is inhibited to an extreme extent. This beneficial effect is provided regardless of whether or not a pair cable for use in feeding the differential signal is large in length.

According to a second aspect of the present invention, in a differential signal-delaying apparatus as defined in the first aspect of the invention, the delay control unit starts changing the delay time difference either when the differential signal-delaying apparatus is switched on or when a pair cable for use in entering the differential signal is inserted. Then, the delay control unit sets the respective delay times in the first and second delay unit to respective delay times that determine a delay time difference in which the number of times of errors per predetermined time is minimized.

The above-structured differential signal-delaying apparatus ensures that the delay time difference in which the number of times of errors per predetermined time is minimized is located when there is a possibility of pair cable replacement. As a result, the differential signal-delaying apparatus is able to handle a possible change in differential signal skew.

According to a third aspect of the present invention, in a differential signal-delaying apparatus as defined in the first aspect of the invention, the delay control unit deactivates the error-detecting unit and the counting unit when setting the respective delay times in the first and second delay unit.

The above-structured differential signal-delaying apparatus reduces power consumption.

A fourth aspect of the invention provides a differential signal-delaying apparatus comprising a first delay unit for delaying a first signal of an entered differential signal in order to generate a first delay signal, a second delay unit for delaying a second signal of the entered differential signal in order to generate a second delay signal, an error-detecting unit for detecting an error in a signal that is based on the first and second delay signals, and a delay control unit for varying a delay time difference that is a difference between respective delay times in the first and second delay unit, wherein the error-detecting unit detects the error for each change in delay time difference to be made by the delay control unit, while the delay control unit sets the respective delay times in the first and second delay unit to respective delay times that determine a delay time difference in which no error is detected.

The above-constructed differential signal-delaying apparatus practices the above delay time-setting operation including the step of locating the delay time difference in which no error is detected, and thereby provides a minimized differential signal skew. As a result, the occurrence of differential signal skew-caused errors is suppressed to the greatest degree. This beneficial effect is provided regardless of whether or not a pair cable for use in feeding the differential signal is large in length. In addition, the differential signal-delaying apparatus as discussed above eliminates a counter for counting the number of times of errors, and such a simpler construction is able to achieve the above beneficial effect.

According to a fifth aspect of the invention, in a differential signal-delaying apparatus as defined in the fourth aspect of the invention, the delay control unit starts changing the delay time difference either when the differential signal-delaying apparatus is switched on or when a pair cable for use in entering the differential signal is inserted. Then, the delay control unit sets the respective delay times in the first and second delay unit to respective delay times that determine a delay time difference in which no error is detected.

The above-constructed differential signal-delaying apparatus ensures that the delay time difference in which no error is detected is located when there is a likelihood of pair cable replacement. As a result, the differential signal-delaying apparatus is able to handle a possible change in differential signal skew.

According to a sixth aspect of the present invention, in a differential signal-delaying apparatus as defined in the fourth aspect of the invention, the delay control unit deactivates the error-detecting unit when setting the respective delay times in the first and second delay unit.

The above construction reduces power consumption.

According to the seventh aspect of the present invention, in a differential signal-delaying apparatus as defined in the first or fourth aspect of the invention, the delay control unit varies the delay time difference by controlling the respective delay times in the first and second delay unit by means of first and second control signals to be fed into the first and second delay unit, respectively, wherein the delay time in the first delay unit is linearly varied with a voltage of the first control signal, while the delay time in the second delay unit is linearly varied with a voltage of the second control signal.

The above-structured differential signal-delaying apparatus provides easy control over the delay time difference.

An eighth aspect of the present invention provides a receiver for receiving a differential signal that includes first and second signals, each of which is a serial signal, comprising a differential signal-delaying unit for delaying the first and second signals of the differential signal in order to provide the delayed first and second signals as first and second delay signals, respectively, a differential-amplifying unit for generating an output signal according to a potential difference between the first and second delay signals, a serial/parallel-converting unit for converting the output signal into a parallel signal, which output signal is a serial signal sent out from the differential-amplifying unit, and a decoder for decoding the parallel signal from the serial/parallel-converting unit, the differential signal-delaying unit comprising a first delay unit for delaying the first signal of the differential signal in order to generate the first delay signal, a second delay unit for delaying the second signal of the differential signal in order to produce the second delay signal, an error-detecting unit for generating an error signal when detecting an error in the parallel signal from the serial/parallel-converting unit, a counting unit for counting the number of times of errors per predetermined time upon receipt of the error signal, and a delay control unit for varying a delay time difference that is a difference between respective delay times in the first and second delay unit, wherein the counting unit counts the number of times of errors per predetermined time for each change in delay time difference to be made by the delay control unit, while the delay control unit sets the respective delay times in the first and second delay unit to respective delay times that determine a delay time difference in which the number of times of errors per predetermined time is minimized.

The above-structured differential signal-delaying unit having the above construction practices the above delay time-setting operation including the step of locating the delay time difference in which the number of times of errors per predetermined time is minimized, and thereby provides a minimized differential signal skew. As a result, the occurrence of differential signal skew-caused errors is suppressed to the utmost. This beneficial effect is achievable regardless of whether or not a pair cable for use in receiving the differential signal is great in length.

According to a ninth aspect of the present invention, in a receiver as defined in the eight aspect of the invention, the delay control unit starts changing the delay time difference either when the receiver is switched on or when a pair cable for use in feeding the differential signal is inserted into the receiver, and then the delay control unit sets the respective delay times in the first and second delay unit to respective delay times that determine a delay time difference in which the number of times of errors per predetermined time is minimized.

The above-constructed differential signal-delaying unit ensures that the delay time difference in which the number of times of errors per predetermined time is minimized is located when there is a likelihood of pair cable replacement. As a result, the differential signal-delaying unit is able to take care of a possible change in the differential signal skew.

According to a tenth aspect of the present invention, in a receiver as defined in the eighth aspect of the invention, the delay control unit deactivates the error-detecting unit and the counting unit when setting the respective delay times in the first and second delay unit.

This construction reduces power consumption.

An eleventh aspect of the present invention provides a receiver for receiving a differential signal that includes first and second signals, each of which is a serial signal, comprising a differential signal-delaying unit for delaying the first and second signals of the differential signal in order to provide the delayed first and second signals as first and second delay signals, respectively, a differential-amplifying unit for generating an output signal according to a potential difference between the first and second delay signals, a serial/parallel-converting unit for converting the output signal into a parallel signal, which output signal is a serial signal sent out from the differential-amplifying unit, and a decoder for decoding the parallel signal from the serial/parallel-converting unit, the differential signal-delaying unit comprising a first delay unit for delaying the first signal of the differential signal in order to generate the first delay signal, a second delay unit for delaying the second signal of the differential signal in order to produce the second delay signal, an error-detecting unit for detecting an error in the parallel signal from the serial/parallel-converting unit, and a delay control unit for varying a delay time difference that is a difference between respective delay times in the first and second delay unit, wherein the error-detecting unit detects the error for each change in delay time difference to be made by the delay control unit, while the delay control unit sets the respective delay times in the first and second delay unit to respective delay times that determine a delay time difference in which no error is detected.

The above-structured differential signal-delaying unit practices the above delay time-setting operation including the step of locating the delay time difference in which no error is detected, and thereby provides a minimized differential signal skew. As a result, the occurrence of differential signal skew-caused errors is suppressed to an extreme extent. This beneficial effect is achievable regardless of whether or not a pair cable for use in receiving the differential signal is great in length. In addition, the differential signal-delaying unit as discussed above is free of a counter for counting the number of times of errors, and such a simpler construction is able to achieve the above beneficial effect.

According to a twelfth aspect of the present invention, in a receiver as defined in the eleventh aspect of the invention, the delay control unit starts changing the delay time difference either when the receiver is switched on or when a pair cable for use in feeding the differential signal is inserted into the receiver, and then the delay control unit sets the respective delay times in the first and second delay unit to respective delay times that determine a delay time difference in which no error is detected.

The above-constructed differential signal-delaying unit ensures that the delay time difference in which no error is detected is located when there is a possibility of pair cable replacement. As a result, the differential signal-delaying unit is able to take care of a possible change in a differential signal skew.

According to a thirteenth aspect of the present invention, in a receiver as defined in the eleventh aspect of the invention, the delay control unit deactivates the error-detecting unit when setting the respective delay times in the first and second delay unit.

This construction reduces power consumption.

According to a fourteenth aspect of the present invention, in a receiver as defined in the eighth or eleventh aspect of the invention, the receiver receives the differential signal that includes first and second signals, each of which is a 10-bit redundant code, while the decoder decodes the parallel signal from the serial/parallel-converting unit, which parallel signal is the 10-bit redundant code, and thereby provides the decoded parallel signal as 8-bit parallel data.

The above-constructed receiver is possible to handle a redundant code produced by means of an encoding algorithm according to the DVI specification.

According to a fifteenth aspect of the present invention, in a receiver as defined in the eighth or eleventh aspect of the invention, the delay control unit varies the delay time difference by controlling the respective delay times in the first and second delay unit by means of first and second control signals to be entered into the first and second delay unit, respectively. The delay time in the first delay unit is linearly varied with a voltage of the first control signal, while the delay time in the second delay unit is linearly varied with a voltage of the second control signal.

The above-structured delay control unit realizes easy control over the delay time difference.

A sixteenth aspect of the present invention provides a communication system including a transmitter and a receiver, which are communicated with one another through a pair cable, the receiver receiving a differential signal from the transmitter, the receiver comprising a differential signal-delaying unit for delaying the differential signal, the differential signal-delaying unit comprising a first delay unit for delaying a first signal of the differential signal in order to generate a first delay signal, a second delay unit for delaying a second signal of the differential signal in order to generate a second delay signal, an error-detecting unit for generating an error signal when detecting an error in a signal that is based on the first and second delay signals, a counting unit for counting the number of times of errors per predetermined time upon receipt of the error signal, and a delay control unit for varying a delay time difference that is a difference between respective delay times in the first and second delay unit, wherein the counting unit counts the number of times of errors per predetermined time for each change in delay time difference to be made by the delay control unit, while the delay control unit sets the respective delay times in the first and second delay unit to respective delay times that determine a delay time difference in which the number of times of errors per predetermined time is minimized.

The above-structured differential signal-delaying unit practices the above delay time-setting operation including the step of locating the delay time difference in which the number of times of errors per predetermined time is minimized, and thereby provides a minimized differential signal skew. As a result, the occurrence of differential signal skew-caused errors is suppressed to an extreme extent. This beneficial effect is achievable regardless of whether or not a pair cable for use in transmitting the differential signal is large in length.

A seventeenth aspect of the present invention provides a communication system including a transmitter and a receiver, which are communicated with one another through a pair cable, the receiver receiving a differential signal from the transmitter, the receiver comprising a differential signal-delaying unit for delaying the differential signal, the differential signal-delaying unit comprising a first delay unit for delaying a first signal of the differential signal in order to generate a first delay signal, a second delay unit for delaying a second signal of the differential signal in order to generate a second delay signal, an error-detecting unit for detecting an error in a signal that is based on the first and second delay signals, and a delay control unit for varying a delay time difference that is a difference between respective delay times in the first and second delay unit, wherein the error-detecting unit detects the error for each change in delay time difference to be made by the delay control unit, while the delay control unit sets the respective delay times in the first and second delay unit to respective delay times that determine a delay time difference in which no error is detected.

The above-structured differential signal-delaying unit practices the above delay time-setting operation including the step of locating the delay time difference in which no error is detected, and thereby provides a minimized differential signal skew. As a result, the occurrence of differential signal skew-caused errors is inhibited to the largest extent. This beneficial effect is achievable regardless of whether or not a pair cable for use in transmitting the differential signal is large in length. In addition, the differential signal-delaying unit as discussed above is free of a counter for counting the number of times of errors, and such a simper structure is able to achieve the beneficial effect.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a block diagram, illustrating a communication system according to a first embodiment of the present invention;

FIG. 2 is a block diagram, illustrating the details of the receiver of FIG. 1;

FIG. 3(a) is a descriptive illustration, showing the signal path of the delay unit of FIG. 2;

FIG. 3(b) is a timing diagram showing the delay time;

FIG. 3(c) is a graph illustrating the relationship between the voltage of a control signal and the delay time signal means of a control signal and the delay unit according to an embodiment of the present invention;

FIG. 3(d) is a table also illustrating the relationship between the voltage of a control signal and the delay time signal means of a control signal and the delay unit according to an embodiment of the present invention;

FIG. 4 is a table illustrating an adjustment mode assumed by the differential signal-delaying unit of FIG. 2;

FIG. 5(a) is a timing diagram showing a waveform of an output signal from a differential-amplifying unit of FIG. 2 when the differential signal-delaying unit is in the adjustment mode;

FIG. 5(b) is a timing diagram showing a waveform of an output signal from the differential-amplifying unit of FIG. 2 when the differential signal-delaying unit is in a fixed mode;

FIG. 6 is a block diagram illustrating a receiver according to a second embodiment of the present invention;

FIG. 7 is a block diagram illustrating a receiver in a prior art communication system;

FIG. 8(a) is a timing diagram generally illustrating a differential signal skew known in the prior art;

FIG. 8(b) is a timing diagram generally illustrating a waveform of an output signal from a differential-amplifying unit of the prior art in the presence of the differential signal skew; and

FIG. 8(c) is a timing diagram showing a waveform of an output signal from a differential-amplifying unit in the absence of the skew.

### DETAILED DESCRIPTION OF THE PREFERRED EMBODIMENTS

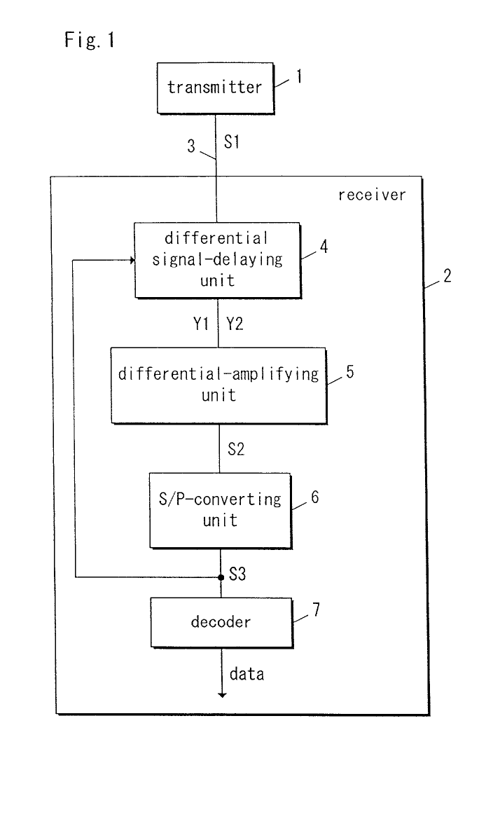

FIG. 1 is a block diagram illustrating a communication system according to a first embodiment of the present invention. The communication system includes a transmitter 1 and a receiver 2. A twisted-pair cable 3 interconnects the transmitter 1 and the receiver 2. Receiver 2 includes a differential signal-delaying unit 4, a differential-amplifying unit 5, a serial/parallel-converting unit (S/P-converting unit) 6, and a decoder 7.

Transmitter 1 encodes display information, e.g., a video signal, thereby producing a redundant code. Transmitter 1 then generates differential signal “S1” according to the resulting redundant code, and then sends differential signal S1 to the receiver 2 through the twisted-pair cable 3. Differential signal S1 includes one signal X1 and another X2, which are serial signals and which are opposite in polarity to one another. Transmitter 1 may be a set-top box (STB) and receiver 2 may be a television.

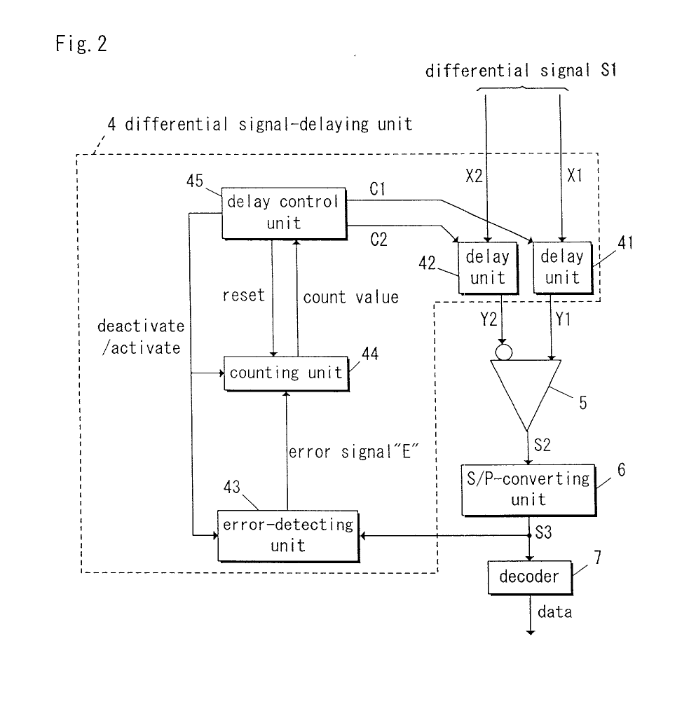

FIG. 2 is a block diagram, illustrating the receiver 2 of FIG. 1. As illustrated in FIG. 2, the differential signal-delaying unit 4 includes a pair of delay units 41, 42, an error-detecting unit 43, a counting unit 44, and a delay control unit 45.

Receiver 2 will operate as described below. One signal X1 is fed into delay unit 41. Delay unit 41 delays fed signal X1 in accordance with control signal C1 from the delay control unit 45, and then provides signal X1 as delay signal Y1. Another signal X2 enters the delay unit 42. Delay unit 42 delays signal X2 in accordance with control signal C2 from delay control unit 45, and then provides signal X2 as delay signal Y2.

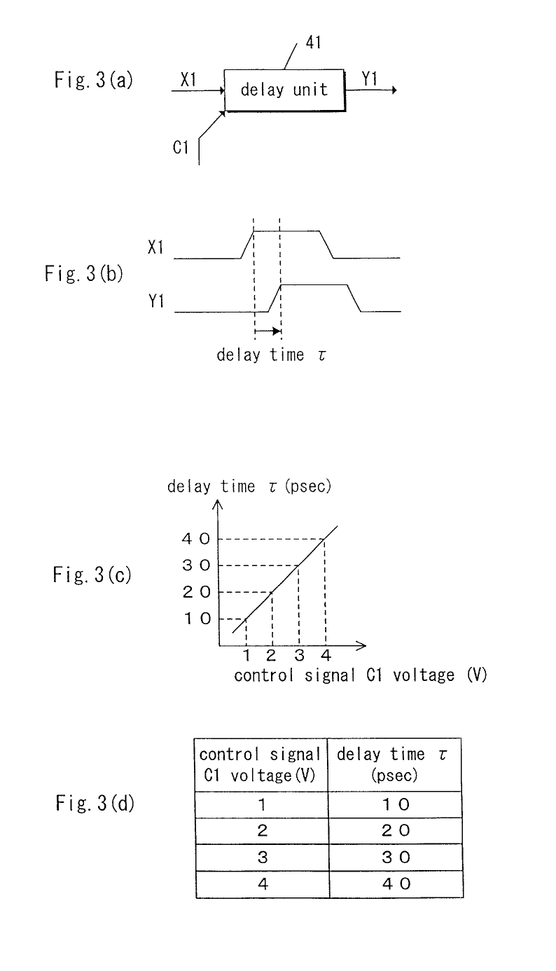

FIGS. 3(a)-3(d) illustrate details of behavior provided by the delay unit 41 of FIG. 2. FIG. 3(a) illustrates how the signals enter and leave the delay unit 41. FIG. 3(b) illustrates the delay time in the delay unit 41. FIG. 3(c) is a graph, illustrating a relationship between a voltage (V) of control signal C1 sent to the delay unit 41 and the delay time (psec) in the delay unit 41. FIG. 3(d) is a table, illustrating a relationship between the voltage (V) of control signal C1 and the delay time (psec) in the delay unit 41.

As illustrated in FIGS. 3(a) and 3(b), delay unit 41 delays the entered signal X1 by an amount of delay time τ in accordance with control signal C1, and then provides the signal X1 as delay signal Y1.

FIGS. 3(c) and 3(d) illustrate that the delay time τ in delay unit 41 is linearly varied with the voltage of control signal C1. Similarly, a delay time in the delay unit 42 is linearly varied with a voltage of control signal C2 that is sent from the delay control unit 45, and assumes characteristics as illustrated in FIGS. 3(c), 3(d).

Although the linear variations of the respective delay times in the delay unit 41, 42 with the respective voltages of control signals C1, C2 have been described by way of illustration; the present invention is not limited thereto. Any relationship between the delay times in the delay unit 41, 42 and the voltages of control signals C1, C2 may be established.

Returning to FIG. 2, it shows that delay unit 41 provides delay signal Y1 to differential-amplifying unit 5 at one terminal thereof. Delay unit 42 provide delay signal Y2 to another terminal of differential-amplifying unit 5. Differential-amplifying unit 5 then generates output signal “S2” according to the potential difference between respective delayed signals Y1 and Y2. Differential-amplifying unit 5 delivers signal S2 (a serial signal) to serial/parallel converting unit 6, in which signal S2 (the serial signal) is converted into parallel signal S3. Serial/parallel converting unit 6 produces parallel signal S3 (a redundant code) that it provides to decoder 7. Decoder 7 decodes the parallel signal S3 into original data, thereby providing the decoded original data.

Serial/parallel converting unit 6 also provides parallel signal S3 (the redundant code) to the error-detecting unit 43. Error-detecting unit 43 detects an error in parallel signal S3, and sends out error signal “E” to the counting unit 44 upon detection of the error. Counting unit 44, upon receipt of error signal “E”, counts the number of times the error signal E is received within a predetermined time. Error signal “E” is sent from error-detecting unit 43 each time error-detecting unit 43 detects an error in parallel signal S3. Counting unit 44 sends out information (a count value) on the counted of the number of errors per predetermined time to delay control unit 45.

Counting unit 44 has a maximum countable value set therein, and stops counting when the maximum value is reached. Thus, counting unit 44 is provided with an overflow-preventing function. The overflow-preventing function inhibits malfunction of counting unit 44.

As noted above, differential signal-delaying unit 4 including the delay control unit 45. The differential signal-delaying unit 4 has two modes of operation, i.e., an adjustment mode and a fixed mode. In adjustment mode, delay control unit 45 controls the respective voltages of control signals C1, C2 that are directed to delay units 41, 42, respectively. Such voltage controls vary with the respective delay times in delay units 41, 42 in such a manner that a difference (hereinafter called a “delay time difference”) between the respective delay times in delay unit 41, 42 is varied at certain time intervals. The changes made by delay control unit 45 refer to respective variations in output timing of delay signal Y1 and that of delay signal Y2.

For each change in delay time difference to be made by delay control unit 45, counting unit 44 counts the number of times that errors occur within a predetermined time, and then sends out a count value to delay control umit 45. Delay control unit 45 then sets the respective delay times in the delay unit 41, 42 to a delay time difference where the number of errors per predetermined time is minimized. Specifically, delay control unit 45 sets the respective voltages of control signals C1, C2 to respective voltages in which the number of errors per predetermined time is minimized.

Delay control unit 45 deactivates the error-detecting unit 43 and counting unit 44 after setting the respective voltages of control signals C1, C2, and the differential signal-delaying unit 4 goes into a fixed mode. By switching into a fixed mode, power consumption is reduced.

Delay control unit 45 resets the count value in counting unit 44 to zero for each change in delay time difference, while counting unit 44 counts the number of errors per predetermined time for each change in delay time difference.

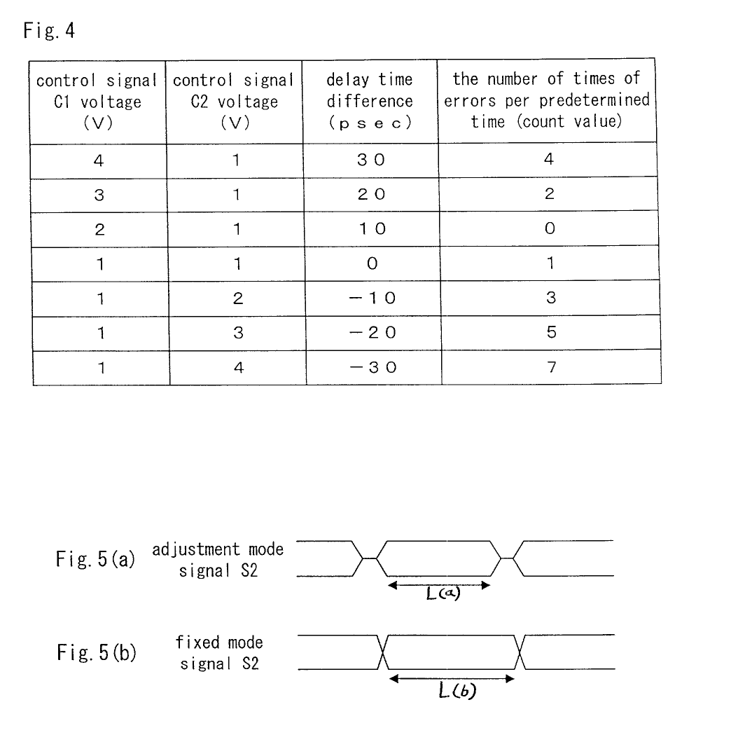

FIG. 4 illustrates a table showing the behavior of delay control unit 45 in the adjustment mode. FIG. 4 illustrates a relationship between respective voltages of control signal C1, C2 and a delay time difference. This relationship between the voltage of control signal C1 (or control signal C2) and a delay time in delay unit 41 (or delay unit 42) is established in a manner as illustrated in FIGS. 3(c) and 3(d).

As illustrated in FIG. 4, delay control unit 45 varies the respective voltages of control signals C1, C2 in order to vary the delay time difference at certain time intervals, i.e., at 10-psec intervals for each volt of signal. FIG. 4 illustrates that the delay time difference is equal to the delay time in delay unit 41 minus the delay time in delay unit 42. As an example, the delay time difference is 30 pico-second (psec) when control signals C1, C2 have respective voltages of 4 volts and 1 volt, i.e., a 3-volt difference.

Counting unit 44 counts the number of errors per predetermined time for each change in delay time difference to be made by delay control unit 45, and then sends out a count value to the delay control unit 45. When the delay time difference is 10 psec, then the number of errors per predetermined time is minimized or approximately zero. Accordingly, delay control unit 45 sets the respective voltages of control signals C1, C2 to 2 V and 1 V, respectively, because 2 V and 1 V are voltages that are determined when the delay time difference is 10 psec. In particular, when the respective voltages of control signals C1, C2 are set to 2 V and 1 V, respectively, then the respective delay times in the delay unit 41, 42 are set to 20 psec and 10 psec, respectively. See FIG. 3(d).

Once the control voltages for minimum errors are selected, the differential signal-delaying unit 4 will then go into a fixed mode.

As discussed above, delay control unit 45 varies the delay time difference between delay signals Y1, Y2. Such a variation in delay time difference refers to variations in the difference in time in which delay signals Y1, Y2 arrive at differential-amplifying unit 5. This difference in delay signal arrival time is called a differential signal skew. Accordingly, the differential signal skew can be varied with a change in delay time difference made by delay control unit 45.

It can be assumed that the differential signal skew brings about errors and the number of times the errors occur in a predetermined time varies with a change in delay time difference. Further, the number of errors per predetermined time increases as the differential signal skew increases, while a decrease in the number of errors per predetermined time indicates a decrease in the differential signal skew.

Delay control unit 45 sets the respective delay times in delay units 41, 42 to a delay time difference in which the number of errors per predetermined time is minimized, i.e., a delay time difference in which the differential signal skew is minimized.

The above delay time-setting operation includes the step of locating the delay time difference at which the number of errors per predetermined time is minimized so as to provide a minimized differential signal skew. This results in inhibiting differential signal skew-caused errors to the utmost. This can be achieved with a storage unit that is part of the delay control unit that is instructed, e.g., by other parts of the delay control unit, to store the C1, C2 values when the minimum error rate is achieved.

The above beneficial effect can be achieved regardless of the length of twisted-pair cable 3. Typically, differential signal-delaying unit 4 is thought to receive a differential signal with a greater skew when the signal is received over a longer twisted-pair cable 3, rather than over a shorter one. However, the above beneficial effect is provided irrespective of the size of the skew of the differential signal that is received by differential signal-delaying unit 4. Consequently, the occurrence of differential signal skew-caused data errors is suppressed to an extreme extent, even if a twisted-pair cable 3 is longer than that what is customarily used. For example, video disturbance can be inhibited to the greatest degree, even with the receipt of a video signal through a long twisted-pair cable.

Next, when differential signal-delaying unit 4 is in a fixed mode, the delay control unit 45 continues to generate control signals C1, C2 after setting the respective voltages thereof to respective voltages in which the number of errors per predetermined time is minimized. For example, delay control unit 45 would continue to generate control signals C1, C2 after setting the voltages thereof to 2 V and 1 V, respectively, in which the number of errors per predetermined time is minimized.

When there is a possibility that the existing twisted-pair cable 3 may be replaced by another twisted-pair cable or there is some other reason why the signal slew may change, the system can be altered so that the adjustment mode is entered whenever, e.g., the receiver 2 is switched on a twisted-pair cable 3 is connected to receiver 2. Then, the delay control unit 45 actuates error-detecting unit 43 and counting unit 44, and differential signal-delaying unit 4 is switched into the adjustment mode.

As discussed above, differential signal-delaying unit 4 is switched into adjustment mode in response to the possibility that the twisted-pair cable 3 will be replaced, even after differential signal-delaying unit 4 has been set to the fixed mode from the adjustment mode.

The twisted-pair cable replacement will change the differential signal skew, and the difference signal skew must be minimized by the above delay time-setting operation. This again includes the step of locating the delay time difference in which the number of errors per predetermined time is minimized, in order to suppress the occurrence of the new differential signal skew-caused errors.

FIG. 4 clearly illustrates that the delay time difference can be controlled with ease when the respective delay times in the delay unit 41, 42 are linearly varied with the respective voltages of control signals C1, C2, respectively, as illustrated in FIGS. 3(c) and 3(d).

FIGS. 5(a) and 5(b) are descriptive illustrations showing the operations of the present invention. FIG. 5(a) illustrates a timing diagram (an overlapped waveform) of the differential signals making up signal S2, which is sent from the differential-amplifying unit 5 when the differential signal-delaying unit 4 is in the adjustment mode. Signal S2 is generated when a differential signal skew is large, not when the number of errors per predetermined time is minimized.

In the adjustment mode, signal S2 has several waveforms (a waveform for each delay time difference). FIG. 5(a) illustrates one such waveforms, which includes a large-sized skew. FIG. 5(b) illustrates a timing diagram of signal S2 sent from differential-amplifying unit 5 when the skew is small and the differential signal-delaying unit 4 has been set to the fixed mode. In particular, signal S2 is generated when the number of errors per predetermined time is minimized, or rather when the differential signal skew is minimized.

As shown in FIGS. 5(a) and 5(b), the pattern of signal S2 in the fixed mode (FIG. 5(b)) has a greater bit width L(b) than that in the adjustment mode, L(a) (FIG. 5(a)). This means that data is set to be 0 (zero) or otherwise 1 (one) at longer time intervals in fixed mode that sets the respective delay times in the delay unit 41, 42 to a delay time difference in which the number of errors per predetermined time is minimized. As a result, a data value is decided as either 0 (zero) or 1 (one) with improved certainty, and the occurrence of the difference signal skew-caused errors is inhibited.

In order to make the above-described communication system consistent with the DVI specification, transmitter 1, serial/parallel-converting unit 6, and decoder 7 as illustrated in FIG. 1, and error-detecting unit 43 of FIG. 2, are constructed in a manner described below. The remaining components are constructed in the manner discussed above.

Transmitter 1 encodes original 8-bit data (e.g., a 8-bit video signals), thereby producing a 10-bit redundant code including 2-bit redundant bit (hereinafter called a 8B10B code). This encoding performance is according to an algorithm that conforms to the DVI specification. The other aspects of transmitter 1 are similar to those previously described.

Differential-amplifying unit 5 feeds signal S2 (a 10-bit serial signal) to serial/parallel converting unit 6, in which signal S2 is converted into 10-bit parallel signal S3. Serial/parallel converting unit 6 delivers parallel signal S3 (the 8B10B code) to decoder 7. Decoder 7 decodes parallel signal S3 into the original 8-bit parallel data, thereby providing the decoded data. The decoding performance is according to an algorithm that conforms to the DVI specification.

Serial/parallel converting unit 6 feeds parallel signal S3 (the 8B10B code) into error-detecting unit 43. Error-detecting unit 43 detects an error in parallel signal S3 and sends out error signal “E” to counting unit 44.

The error detection will now be described in more detail with reference to FIG. 2. Error-detecting unit 43 detects the words of the 8B10B code that are fed from serial/parallel-converting unit 6. When a detected word is absent in an 8B10B code word list, the error-detecting unit 43 sends out the error signal E to the counting unit 44. A word list for the original 8-bit data is provided when the 8B10B code is decoded.

In a preferred embodiment, error-detecting unit 43 is achievable by means of a read-only memory (ROM) having a 10-bit input width in order to feed 10-bit parallel signal S3 into the error-detecting unit 43 and further having a 1-bit output width in order to generate error signal “E.”

The present invention is not limited to a ROM. For example, error-detecting unit 43 can be realized by an AND-OR gate, or alternatively by any other methods publicly known to those skilled in the art, e.g., a software algorithm.

The communication system according to the present embodiment is compatible in code with standards according to the DVI specification. Thus, the occurrence of differential signal skew-caused errors is limited to an extreme extent, even with the use of a redundant code or rather 8B10B code, which is produced by means of an encoding algorithm according to the DVI specification.

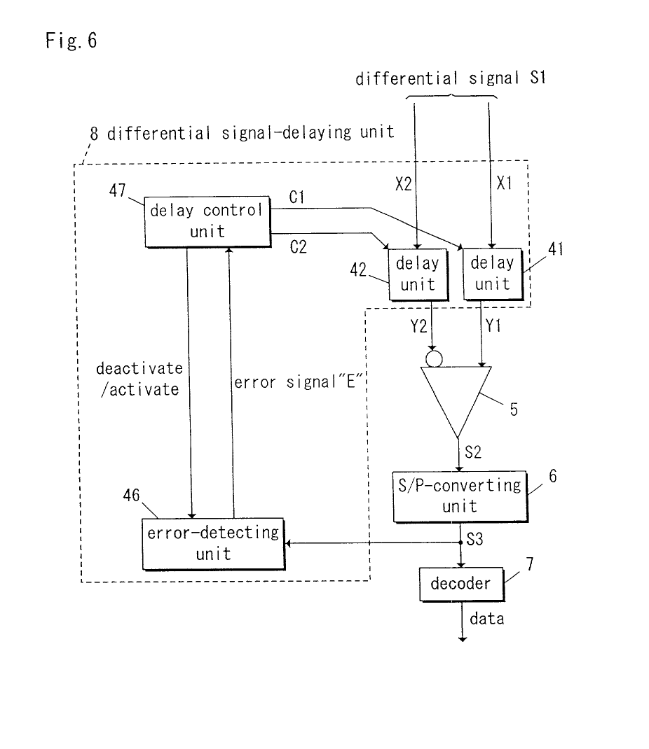

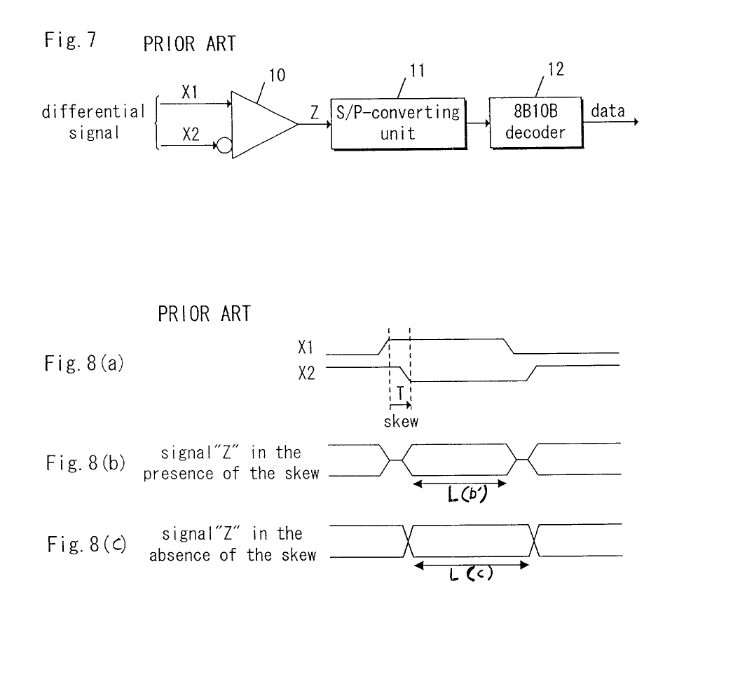

FIG. 6 is a block diagram illustrating a receiver according to a second embodiment. The receiver of FIG. 6 is used in a communication system similar in construction to the communication system illustrated in FIG. 1. In FIG. 6, the same components as those of the receiver of FIG. 2 are identified by the same characters, and descriptions related thereto are omitted.

As illustrated in FIG. 6, a differential signal-delaying unit 8 includes a pair of delay unit 41, 42, an error-detecting unit 46, and a delay control unit 47. The differential signal-delaying unit 8 differs from differential signal-delaying unit 4 according to the first embodiment of FIG. 2 in that the counting unit 44 is absent.

Serial/parallel-converting unit 6 feeds parallel signal S3 (a redundant signal) into the error-detecting unit 46, in which an error in parallel signal S3 is detected. Upon detection of the error, the error-detecting unit 46 sends out error signal “E” to delay control unit 47. Similar to the previous embodiment, differential signal-delaying unit 8, including delay control unit 47, has an adjustment mode and a fixed mode. In the adjustment mode, delay control unit 47 controls respective voltages of control signals C1, C2 which are applied to delay units 41, 42, respectively. Such voltage control varies respective delay times in delay units 41, 42 in such a manner that a difference (delay time difference) between the respective delay times in delay units 41, 42 is varied at given time intervals. Delay control unit 47 sets the respective delay times in delay unit 41, 42 to respective delay times that determine a delay time difference in which no error is detected by error-detecting unit 46. More specifically, delay control unit 47 sets the respective voltages of control signals C1, C2 to various voltages until respective voltages are found in which no error is detected, i.e., a delay time difference in which a differential signal skew is minimized.

Following the above voltage-setting operation, delay control unit 47 deactivates error-detecting unit 46, and then differential signal-delaying unit 8 is switched to a fixed mode, which reduces power consumption.

Delay control unit 47 checks the error signal from error-detecting unit 46 to see whether an error has been detected. As described above, delay control unit 47 sets the respective delay times in delay units 41, 42 to a delay time difference in which no error is detected. The delay time-setting operation includes means for and the step of locating the delay time difference in which no error is detected, and providing a minimized differential signal skew, thereby making it feasible to limit the occurrence of differential signal skew-caused errors as much as possible.

Similar to the previous embodiment, the above beneficial effect is achievable regardless of the length of twisted-pair cable 3. As a result, the occurrence of differential signal skew-caused data errors is inhibited to the utmost, even when a length of twisted-pair cable is employed that is longer than what is customary used, currently or in the future. For example, video disturbance can be suppressed to an extreme extent, even when a video signal is received through a long twisted-pair cable.

In addition, the second embodiment eliminates counting unit 44 and is a simpler construction that provides the above beneficial effect.

Lastly, when the differential signal-delaying unit is in the fixed mode, delay control unit 47 continues to generate control signals C1, C2 after setting the respective voltages of control signals C1, C2 to respective voltages thereof in which no error is detected. When there is likelihood that the existing twisted-pair cable will be replaced by another twisted-pair cable or the skew will vary for some other reason, the delaying unit will switch into the adjustment mode, e.g. when the receiver 2 is switched on or when a twisted-pair cable is connected to the receiver 2. Then, the delay control unit 47 actuates error-detecting unit 46. This step is taken for a reason similar to that in the previous embodiment.

Similar to the first embodiment, the above-described second embodiment of a communication system can be made to conform to the DVI specification.

Thus, while there have been shown, described, and pointed out fundamental novel features of the invention as applied to preferred embodiments thereof, it will be understood that various omissions, substitutions, and changes in the form and details of the devices illustrated, and their operation, may be made by those skilled in the art without departing from the spirit and scope of the invention. For example, it is expressly intended that all combinations of those elements and/or steps, which perform substantially the same function, in substantially the same way, to achieve the same results, be within the scope of the invention. Substitutions of elements from one described embodiment to another are also fully intended and contemplated. It is also to be understood that the drawings are not necessarily drawn to scale, but they are merely conceptual in nature. It is the intention, therefore, to be limited only as indicated by the scope of the claims appended hereto.

What is claimed is:

1. A differential signal-delaying apparatus comprising:
a first delay means for delaying a first signal of an entered differential signal, the first delay means generating the first delay signal in response to the entered differential signal;
a second delay means for delaying a second signal of the entered differential signal the second delay means generating a second delay signal in response to the entered differential signal;
an error-detecting means for generating an error signal in response to detecting an error in the first delay signal and the second delay signals;
a counting means for counting a number of errors during a during a predetermined time in response to receiving the error signal; and
a delay control means for varying a delay time difference, the delay time difference being a difference between the first delay time and the second delay times in the first delay means and the second delay means,
wherein the counting means counts the number of errors per predetermined time in response to delay time difference means generating the change to the delay time mean difference by the delay control means, and
wherein the delay control means generate delay times in the first delay means and the second delay means that minimize the number of errors per predetermined time.

2. The differential signal-delaying apparatus as defined in claim 1, wherein the delay control means changes the delay time difference whenever the differential signal-delaying apparatus is switched on and whenever a cable for use in entering the differential signal is connected thereto.

3. A differential signal-delaying apparatus as defined in claim 1, wherein the delay control means deactivates the error-detecting means and the counting means after setting the first delay time and the second delay time in the first delay means and second delay means to minimize errors.

4. A differential signal-delaying apparatus comprising:
a first delay means for delaying a first signal of an entered differential signal, the first delay means generating the first delay signal in response to the entered differential signal;
a second delay means for delaying a second signal of the entered differential signal, the second delay means generating a second delay signal in response to the entered differential signal;
an error-detecting means for detecting an error in response to detecting an error in the first delay signal and the second delay signals; and
a delay control means for varying a delay time difference, the delay time means difference being a difference between the first delay and the second delay time in the first delay means and second delay means,
wherein the error-detecting means detects the error for each change in the delay time difference, the delay control means changing the delay time means difference, and
wherein the delay control means sets the delay times in the first delay means and the second delay means so that no error is detected.

5. The differential signal-delaying apparatus as defined in claim 4, wherein the delay control means changes the delay time difference in response to the differential signal-delaying apparatus being switched on and in response to connecting a cable thereto, the delay control means setting the delay time in the first delay means and second delay time means in the second delay means so that no error is detected.

6. The differential signal-delaying apparatus as defined in claim 4, wherein the delay control means deactivates the error-detecting in response to setting the respective delay times in the first delay means and second delay means.

7. The differential signal-delaying apparatus as defined in claim 1, wherein the delay control means varies the delay time difference by controlling the respective delay times in the first delay means and second delay means by generating a first control signal and a second control signal, and feeding the first control signal into the first delay means and the second control signal into the second delay means, and wherein the delay time in the first delay means varies linearly with a voltage of the first control signal, while the delay time in the second delay means is varies linearly with a voltage of the second control signal.

8. The differential signal-delaying apparatus as defined in claim 4, wherein the delay control means varies the delay time difference by controlling the first control time and the second control time by means of a first control signal feeding into the first delay means and a second control signal feeding into and the second delay means, and wherein the delay time in the first delay means is linearly varied with a voltage of the first control signal, while the delay time in the second delay means is linearly varied with a voltage of the second control signal.

9. A receiver for receiving a differential signal comprising a serial signal in the form of a first signal and a second signal:
a differential signal-delaying means for respectively delaying the first signal and the second signal of the differential signal so as to provide a delayed first signal and a delayed second signal as a first delay signal and a second delay signals;
a differential-amplifying means for generating an output signal in response to a difference between the first delay signal and the second delay signal;
a serial/parallel-converting means for converting the output signal into a parallel signal, the output signal being a serial signal sent out from the differential-amplifying means; and
a decoder for decoding the parallel signal received from the serial/parallel-converting means,
the differential signal-delaying means comprising:
a first delay means for delaying the first signal of the differential signal and generating the first delay signal;
a second delay means for delaying the second signal of the differential signal and generating the second delay signal;
an error-detecting means for generating an error signal in response to the detection of an error in the parallel signal;
a counting means for counting the number of errors per predetermined time; and
a delay control means for varying a delay time difference that is a difference between the first delay time and the second delay time in the first delay mean and the second delay mean,
wherein the counting means counts the number of errors per predetermined time in response to changing the delay time difference, and
wherein the delay control means setting the first delay time and the second delay time in the first delay mean and the second delay mean, and determines a delay time difference so the number of errors per predetermined time is minimized.

10. The receiver as defined in claim 9, wherein the delay control means changing the delay time difference in response to one of the group consisting of the receiver being on and a cable being connected into the receiver.

11. The receiver as defined in claim 9, wherein the delay control means deactivates the error-detecting means and the counting means after setting the first delay time for the first delay means and setting the second delay time for the second delay means to minimize the error.

12. A receiver for receiving a differential signal comprising a serial first and second signals:
a differential signal-delaying means for delaying the first signal and second signal of the differential signal, providing a delayed first signal and a delayed second signal as a first delay signal and a second delay signal;
a differential-amplifying means for generating an output signal in response to a potential difference between the first delay signal and the second delay signal;
a serial/parallel-converting means for converting the output signal into a parallel signal, the output signal being a serial signal sent out from the differential-amplifying means; and
a decoder for decoding the parallel signal received from the serial/parallel-converting means,
the differential signal-delaying means comprising:
a first delay means for delaying the first signal of the differential signal and generating the first delay signal;
a second delay means for delaying the second signal of the differential signal and generating the second delay signal;
an error-detecting means for detecting an error in the parallel signal from the serial/parallel-converting means; and
a delay control means for varying a delay time difference, the delay time difference being a difference between the first delay time and the second delay time in the first delay means and the second delay means,
wherein the error-detecting means detects the error for each change in the delay time difference, the delay control means makes the change, and
wherein the delay control means sets the delay time in the first delay and the second delay means, the first delay time and the second delay time determining a delay time difference in which no error is detected.

13. A receiver as defined in claim 12, wherein the delay control means changes the delay time difference in response to one of the group consisting of the receiver being turned on and a cable being connected to the receiver, and
the delay control means sets the first delay time and the second delay time in the first and second delay means to respective delay times.

14. A receiver as defined in claim 12, wherein the delay control means deactivates the error-detecting means in response to a determination of the first delay time and second delay time setting the delay times in the first delay means and second delay means.

15. A receiver as defined in claim 9, wherein the receiver receives the differential signal, the differential signal comprising the first signal and the second signal in the form of a 10-bit redundant code, and wherein the decoder decodes the parallel signal from the serial/parallel-converting means as an 8-bit parallel data signal.

16. A receiver as defined in claim 12, wherein the receiver receives the differential signal, the differential signal comprising the first signal and the second signal in the form of a 10-bit redundant code, and wherein the decoder decodes the parallel signal from the serial/parallel-converting means as an 8-bit parallel data signal.

17. A receiver as defined in claim 9, wherein the delay control means varies the delay time difference by controlling the respective delay times in the first delay means and the second delay means by way of a first control signal applied to the first delay means and a second control signal applied to the second delay means, and wherein the delay time in the first delay means is linearly varied in response to a voltage of the first control signal, and where the delay time in the second delay means is linearly varied in response to a voltage of the second control signal.

18. A receiver as defined in claim 12, wherein the delay control means varies the delay time difference by controlling the respective delay times in the first delay means and the second delay means by means of a first control signal and a second control signal applied to the first and second delay means, respectively, and wherein the delay time in the first delay means is linearly varied in response to a voltage of the first control signal, and wherein the delay time in the second delay means is linearly varied response to a voltage of the second control signal.

19. A communication system comprising:
a transmitter;
a receiver, communicating with the transmitter through a twisted pair cable,
the receiver receiving a differential signal from the transmitter, the receiver comprising a differential signal-delaying means for delaying the differential signal,
the differential signal-delaying means comprising:
a first delay means for delaying a first signal of the differential signal and generating a first delay signal in response to the differential signals;
a second delay means for delaying a second signal of the differential signal and generating a second delay signal in response to the differential signals;
an error-detecting means for generating an error signal in response to detecting an error in the first delay signal and the second delay signal;
a counting means for counting a number of errors per predetermined time in response to receipt of the error signal; and
a delay control means for varying a delay time difference, the delay difference being a difference between the first delay time and the second delay time in the first delay means and the second delay means,
wherein the counting means counts the number of errors per predetermined time for each change in the delay time difference made by the delay control means, and
wherein the delay control means sets the first delay time and the second delay time in the first and second delay means to respective delay times that determine a delay time difference in which the number of errors per predetermined time is minimized.

20. A communication system comprising a transmitter,
a receiver communicating with the transmitter through a twisted pair cable,
the receiver receiving a differential signal from the transmitter, the receiver comprising a differential signal-delaying means for delaying the differential signal,
the differential signal-delaying means comprising:
a first delay means for delaying a first signal of the differential signal to generate a first delay signal in response to the differential signal;
a second delay means for delaying a second signal of the differential signal to generate a second delay signal in response to the differential signal;
an error-detecting means for detecting an error in a signal that is based on the first and second delay signals; and
a delay control means for varying a delay time difference, the delay time difference being a difference between the first delay time and the second delay time in the first delay mean and the second delay means,
wherein the error-detecting means detect the error for each change in the delay time difference, and
wherein the delay control means sets the first delay time and the second delay time in the first delay means and the second delay means, and determines a delay time difference in which no error is detected.

21. A method for differential signal-delaying comprising:
(a) delaying a first signal of the differential signal to form a first delay signal;
(b) delaying a second signal of the differential signal to form a second delay signal;
(c) detecting errors in the first and second delay signals;
(d) counting the number of errors in a predetermined period;
(e) varying a difference between the first delay signal and the second delay signal and rechecking the number of errors; and
(f) setting the first delay means and the second delay means based on minimizing the number of errors.
